(19) United States
(12) Patent Application Publication
(10) Pub. No.: US 2006/0232857 A1
(43) Pub. Date: Oct. 19, 2006

(54) Sliding structure for mobile

(75) Inventors: Li-Sen Chen, Gueishan Township (TW); Tzu-Chang Liao, Gueishan Twonship (TW); Cheng-Jyu Jiang, Gueishan Township (TW)

Correspondence Address: TROXELL LAW OFFICE PLLC, SUITE 1404, 5205 LEESBURG PIKE, FALLS CHURCH, VA, 22041, US

(73) Assignee: Speed Tech Corp.

(21) Appl. No.: 11/377,269

(22) Filed: Mar. 17, 2006

(30) Foreign Application Priority Data
Apr. 19, 2005 (TW) 094206120

(51) Int. Cl. G02B 23/00

(52) U.S. Cl. 359/409

(57) ABSTRACT

A slider having two parts is applied to electric devices, especially those with small sizes and light weights. The slider is made easily and is applied with ease too.

### FIELD OF THE INVENTION

The present invention relates to a sliding structure; more particularly, relates to reciprocating the sliding structure by sliding two frames on each other within a certain stroke.

### DESCRIPTION OF THE RELATED ARTS

Modern mobile phones have two styles: one with a lid and one without. For those having lids, the lids are connected with the main bodies of the mobile phones in specific ways, where those lids move within a certain area or slide within a certain distance of a stroke. The ways used for connecting the lids with the main bodies include one using a chain, another using a shaft and the other using a sliding track.

Regarding the sliding track, as proclaimed in an U.S. Pat. No. 6,822,871 “Sliding-type portable wireless terminal”, a mobile phone of a prior art has a slider comprising a main body and a sub-body, reciprocating by sliding on each other within a certain stroke. The sliding track of the slider is H-bean shaped with a sliding groove for reciprocating along.

For prolonging the lifetime of the sliding track, the sliding track with the sliding groove is made of metal, which increases difficulties in fabricating the sliding track. In addition, the sliding groove requires side slits, which can be made only through a process like shaving, milling or grinding. Yet, these processes are not economical to be applied to those electric products whose prices drop fast.

In the other hand, there is an additional difficulty on fabricating the sliding track. The sliding track must be form through a mechanical process of bending or drawing. As long as metal is elastic, the sliding track obtained through bending or drawing quite often loses its precision even though it is applied to a delicate device. Hence, the prior arts do not fulfill users' requests on actual use.

### SUMMARY OF THE INVENTION

The main purpose of the present invention is to provide an easily fabricated sliding structure for a mobile.

Another purpose of the present invention is to provide a sliding structure which is applied to mobile devices of small sizes and light weights, such as mobile phones, personal digital assistants (PDA), etc.

To achieve the above purposes, the present invention is a sliding structure for a mobile, comprising a frame body and a sliding member, where the frame body comprises an upper frame and a lower frame; the upper frame has a plurality of holes and at least a side sinkage; the lower frame has a plurality of protrusions being drawn from places corresponding to the holes of the upper frame respectively, and at least a side plate corresponding to the side sinkage of the upper frame respectively; at least a sliding track is formed with the side sinkage of the upper frame and the side plate of the lower frame; and the sliding member has at least a sliding plate at a side sliding along the sliding track. Accordingly, a novel sliding structure for a mobile is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a perspective view showing the present invention;

FIG. 2 is an explosive view showing the present invention;

FIG. 3A is an A-A sectional view of the upper frame and the lower frame of the first preferred embodiment;

FIG. 3B shows the assembly of the upper frame and the lower frame;

FIG. 3C shows the firm combination by the protrusions and the holes;

FIG. 4A is an A-A sectional view of the upper frame and the lower frame of the second preferred embodiment;

FIG. 4B shows the assembly of the upper frame and the lower frame; and

FIG. 4C shows the firm combination by the protrusions and the holes.

### DESCRIPTION OF THE PREFERRED EMBODIMENTS

The following descriptions of the preferred embodiments are provided to understand the features and the structures of the present invention.

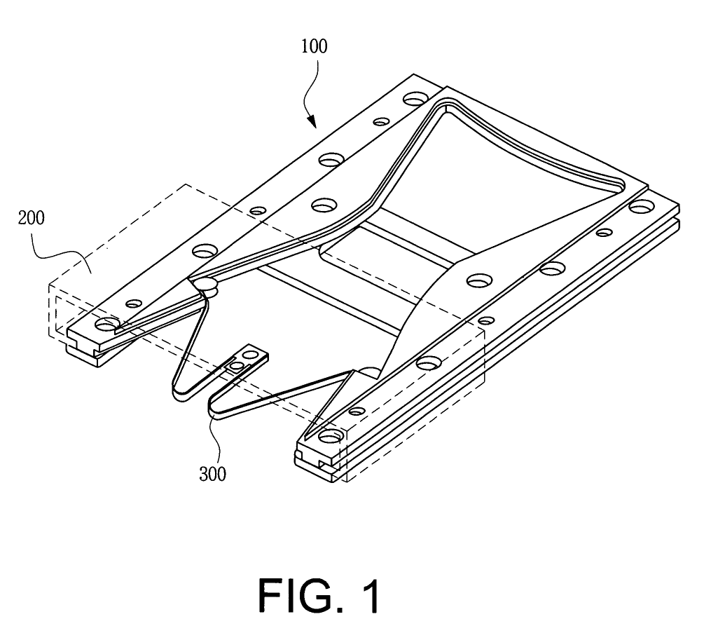

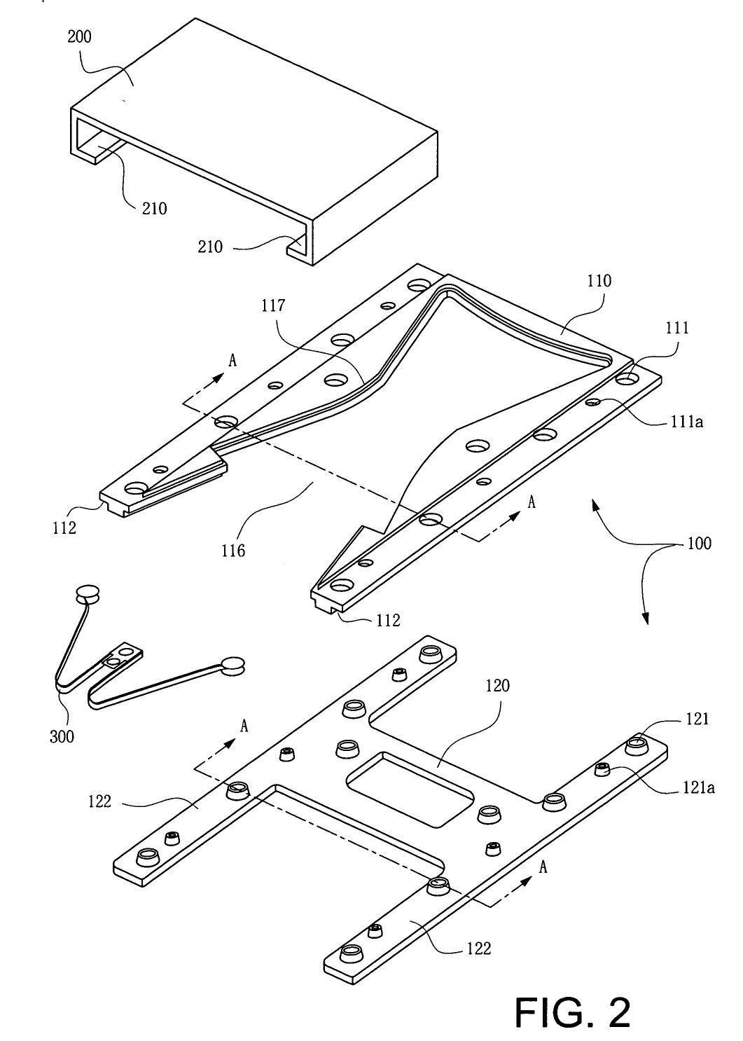

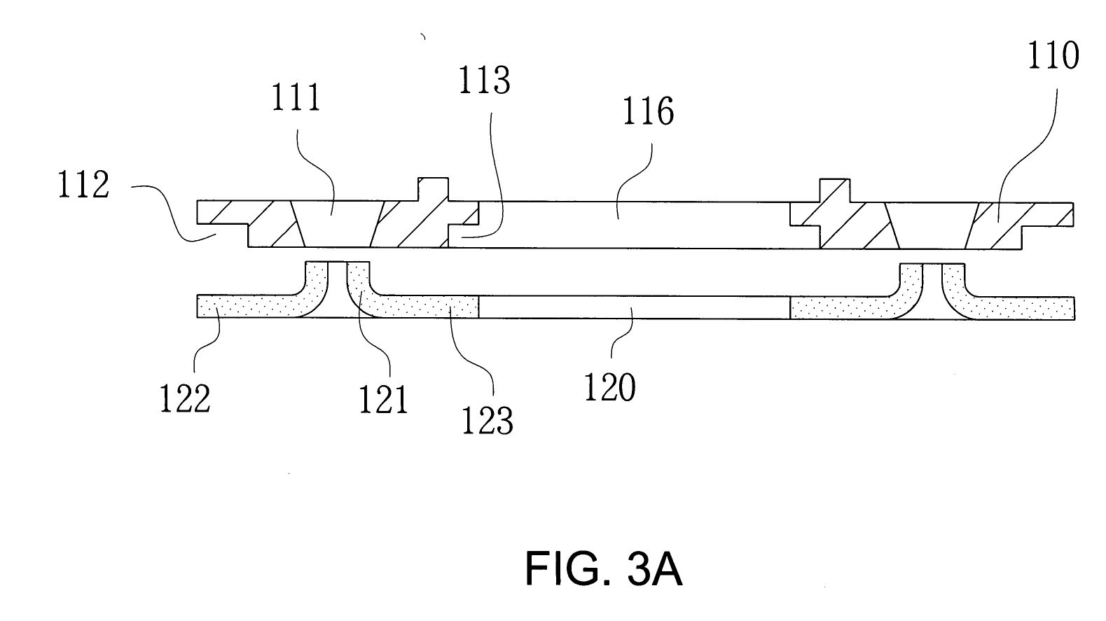

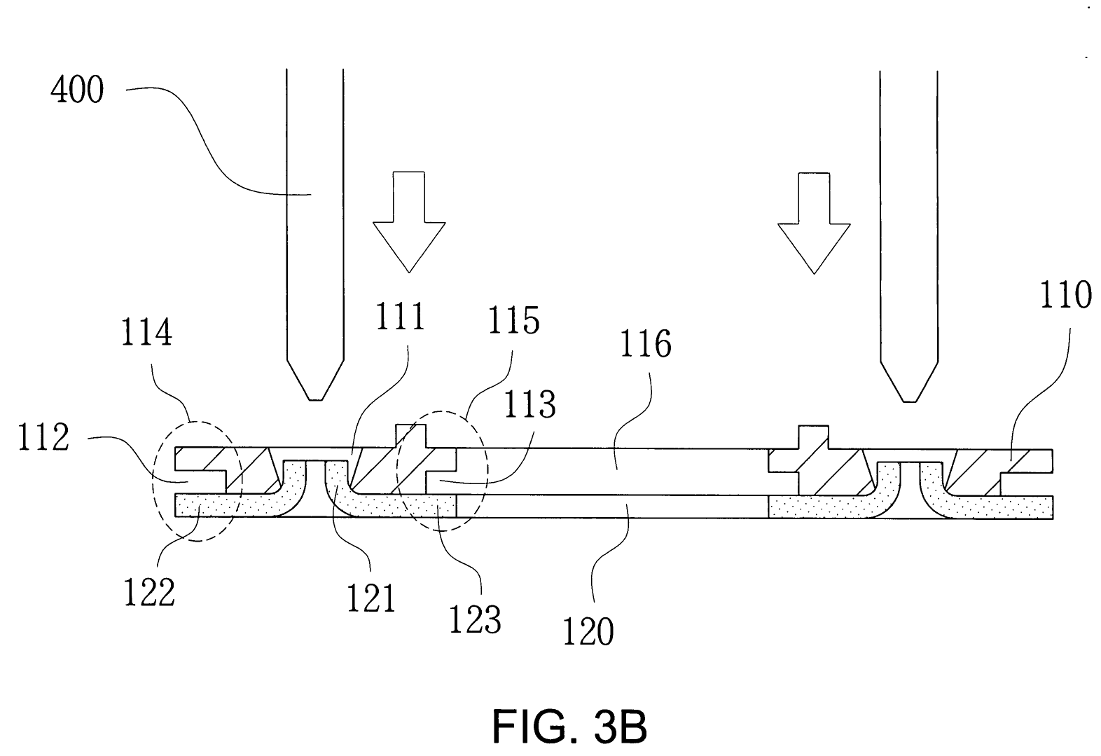

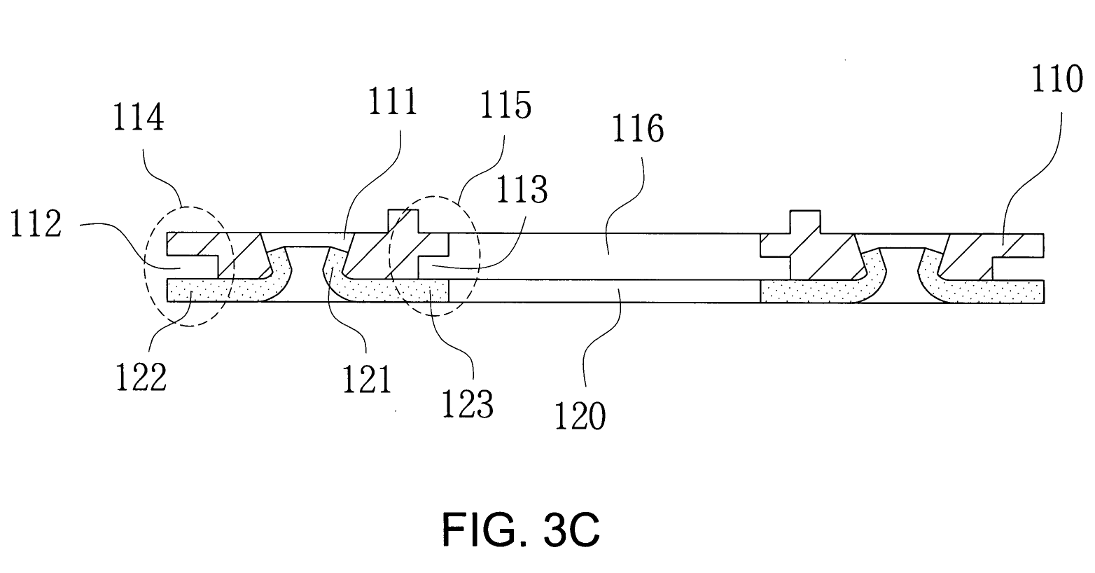

Please refer to FIG. 1 and FIG. 2, which are a perspective view and an explosive view showing the present invention. As shown in the figures, the present invention is a sliding structure for a mobile, comprising a frame body 100 and a sliding member 200, where the frame body 100 comprises an upper frame 110 and a lower frame 120; a plurality of holes 111 and at least a side sinkage 112 are formed on the upper frame 110; the lower frame 120 is made of a metal plate; a plurality of protrusions 121, corresponding to the holes 111 of the upper frame 110, are formed on the lower frame 120 through a drawing process; the protrusions 121 have shapes and sizes being fitted with the holes 111 respectively; the lower frame 120 has at least a side plate 122 corresponding to the side sinkage 112 respectively; at least a sliding track 114 (shown in FIG. 3B) are formed by the side sinkage 112 and the side plate 122; the sliding member 200 has at least a sliding plate 210 corresponding to the sliding track 114; and so the sliding member 200 is slid along the sliding track 114 with the sliding plate 210.

Please refer to FIG. 3A till FIG. 3C, which are an A-A sectional view of the upper frame and the lower frame of the first preferred embodiment; and views showing the assembly of the upper frame and the lower frame and showing the firm combination by the protrusions and the holes. As shown in the figures, the present invention is a sliding structure applied in a mobile phone. Therein, an upper frame 110 and a lower frame 120 of the sliding structure do not need a strong binding force in between before the sliding structure is fixed in the mobile phone. When assembling the present invention, protrusions 121 of the lower frame and holes 111 of the upper frame 110 are aimed at each other to be fixed together a long with the upper frame 110 and the lower frame 120. At the moment, a simple mechanical process, such as punching the protrusions 121 with tools 400, is applied to deform the protrusions 121 so that the upper frame 110 and the lower frame 120 is kept firmly being fixed together.

A first sliding track is formed with a first side sinkage 112 of the upper plate 110 and a side plate 122 of the lower plate 120. Since the upper frame 110 and the lower frame 120 are fabricated separately, the first side sinkage 112 is precisely fabricated on the upper frame 110. For obtaining the first sliding track 114 with a deeper sinkage, the sinking part of the first side sinkage 112 can be enlarged on a fabrication, which is to be fixed with the side plate 122 of the lower frame 120 enlarged as well.

The upper frame 110 and the lower frame 120 are stuck together by aiming the holes 111 and the protrusions 121 at each other respectively. Or, the upper frame 110 and the lower frame 120 can be stuck together through welding, riveting or tightly adhering. The hole 111 is a coned hole of expanding surfaces. The protrusion 121 can be deformed with a tool to obtain another form of a protrusion 121a with a screw thread to be fixed with a screw The above two ways of fixing can be used at the same time. That is, some holes 111 are simply inserted with some protrusions 121 respectively; yet some other holes 111a and some other protrusions 121a (shown in FIG. 1) are fixed through using some screws respectively.

When fixing by using screws, proper screws are used to fix the upper frame 110 and the lower frame 120 so that a frame body 100 (shown in FIG. 1) is fixed on the mobile phone (not shown in the figures). At the moment, the screws are fixed in to the mobile phone and the upper frame 110 and the lower frame 120 are pressed by the screw nuts to fix the frame body 100 on the mobile phone (not shown in the figures). To avoid ruining the protrusions 121, the protrusions 121 here have no screw thread.

In the other hand, please further refer to FIG. 2, the upper frame 100 has an opening 116 having no intersection with the first sliding track 114. A pair of second sliding tracks 115 is formed by two second side sinkages 113 at two non-intersecting sides of the opening 116, and two side plate 123 corresponding to the second side sinkages 113 at two sides of the lower frame 120. When the protrusions 121 are punched by the tools 400, the protrusions 121 are deformed in the holes of the upper frame 110, obtaining a pair of second sliding tracks 115 at two sides of the opening 116.

The pair of the second sliding tracks 115 has a narrowing section 117 and, a driven member 300 with elasticity is slid on the second sliding tracks 115. The driven member 300 is slid along the second sliding tracks 115 in a direction exactly the same as that for the sliding member 200 along the first sliding track 114. The driven member 300 is fixed on the sliding member 200. When the sliding member 200 is slid on the first sliding track 114, the driven member 300 is slid on the second sliding tracks 115 at the same time. By using the driven member 300, the second sliding tracks 115 and the narrowing section 117, the present invention can semi-automatically slides the sliding member 200. The sliding member 200 needs only to be pushed through the narrowing section 117; then the elasticity of the driven member 300 is used to finish the rest of the stroke.

The protrusions 121 of the lower frame 120 are obtained by protruding metal material out of the surface of the lower frame 120 through a drawing process. The protrusions 121 have round mouths on top respectively; thus, when tools 400 are punched on the protrusions 121, the protrusions 121 are deformed in the holes of the upper frame 110 and so the upper frame 110 and the lower frame 120 are fixed at related positions in between.

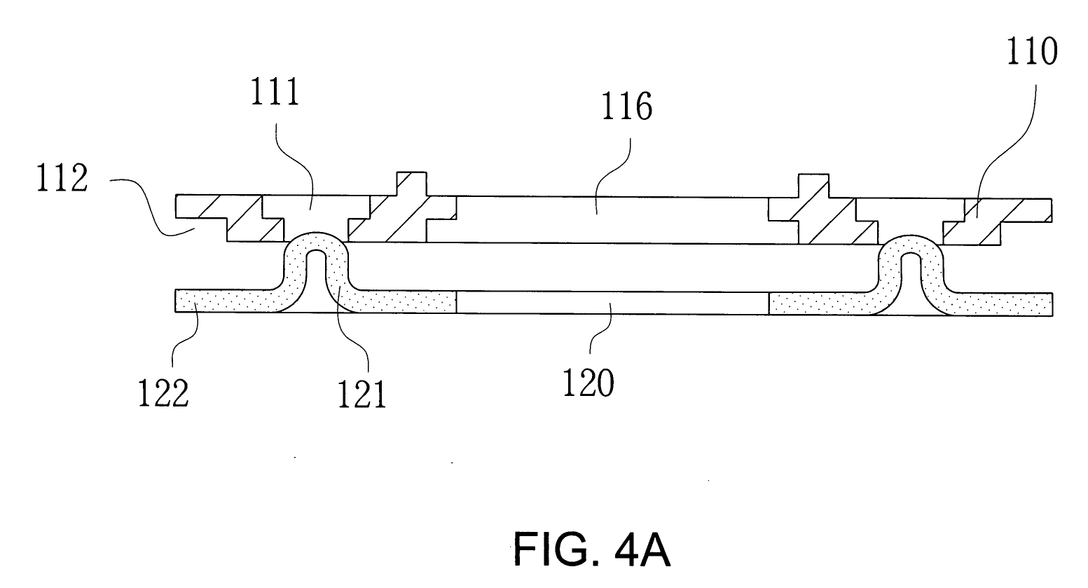

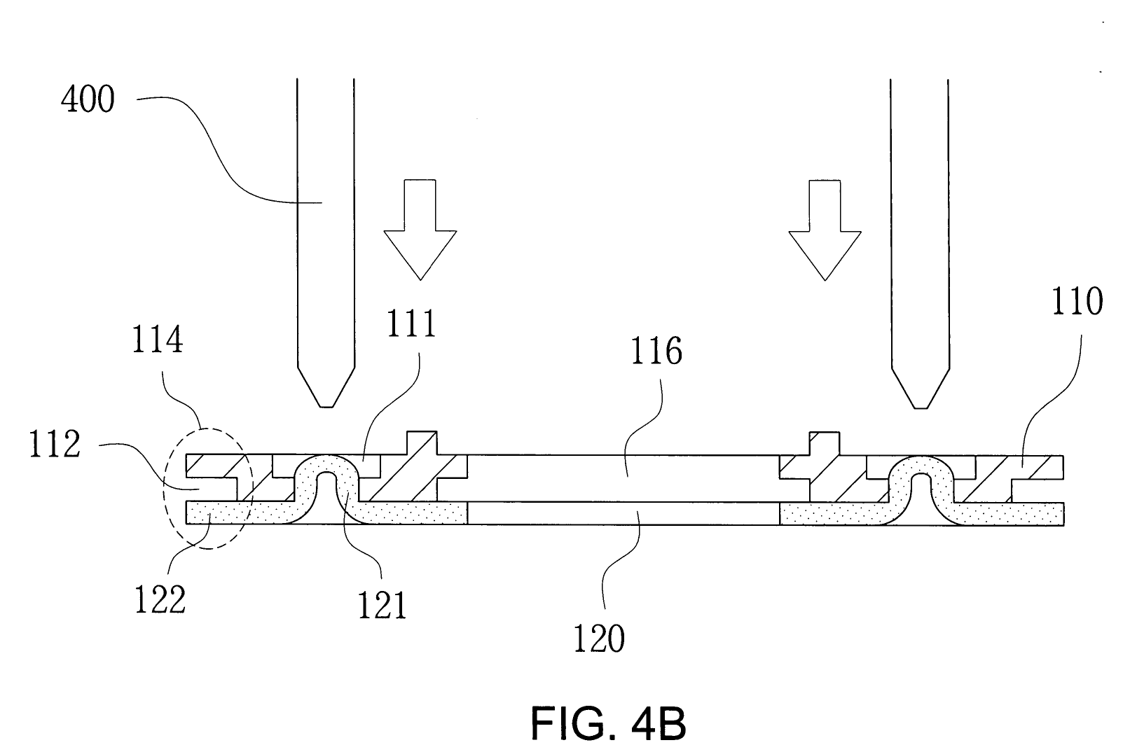

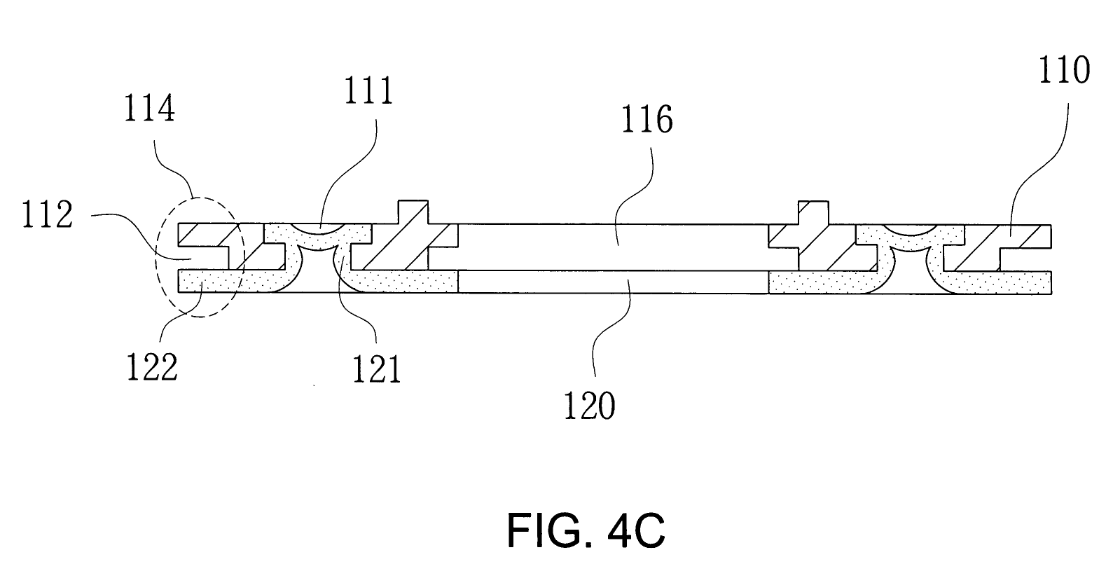

Please refer to FIG. 4A till FIG. 4C which are an A-A sectional view of the upper frame and the lower frame of the second preferred embodiment; and views showing the assembly of the upper frame and the lower frame and the firm combination by the protrusions and the holes. As shown in the figures, the holes 111 of the upper frame 110 are shoulder holes which functions just the same as coned holes do. And the protrusions 121 can be made having no mouth. When tools 400 are punched on the protrusions 121, the protrusions 121 are deformed in the holes 111 of the upper frame 110 and so are hard to be removed.

To sum up, the present invention has the following advantages:

1. A sliding structure for a mobile can be easily fabricated according to the present invention.

2. Such a sliding structure can be applied to electric devices having small sizes and light weights, such as mobile phones, personal digital assistants (PDA), etc.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A sliding structure for a mobile, comprising a frame bony and a sliding member, wherein:
said frame body comprising
an upper frame, said upper frame having
a plurality of holes; and
at least a side sinkage; and
a lower frame, said lower frame having
a plurality of protrusions, said protrusions corresponding to said holes respectively, said protrusions having shapes and sizes being fitted with said holes respectively; and
at least a side plate, said side plate corresponding to said side sinkage respectively; and
said sliding member having: at least a sliding plate, said sliding plate being located at a side of said sliding member,
wherein at least a sliding track is obtained by said side sinkage and said side plate; and
wherein said sliding plate is slid on said sliding track.

2. The sliding structure according to claim 1,
wherein said hole is a coned hole of expanding surfaces.

3. The sliding structure according to claim 1,
wherein said hole is a shoulder hole.

4. The sliding structure according to claim 1,
wherein said upper frame has an opening having no intersection with said sliding track;
wherein said opening has two border lines having no intersection with each other; and
wherein an other sliding track is obtained on said border line by being coordinated with said lower frame.

5. The sliding structure according to claim 4,
wherein said another sliding tracks on said border lines have a narrowing section.

6. The sliding structure according to claim 4,
wherein a sliding driven member with elasticity is deposed on said second sliding track; and
wherein said driven member is fixed on said sliding member.

7. The sliding structure according to claim 4,
wherein said another sliding track is obtained by another side sinkage of said upper frame and another sliding plate of said lower frame.

8. The sliding structure according to claim 1,
wherein said lower frame is made of a metal plate; and
where said protrusion is obtained through a drawing process.

9. The sliding structure according to claim 8,
wherein said protrusion has a screw thread on an inner surface of said protrusion.
